(19) United States
(12) Patent Application Publication
(10) Pub. No.: US 2010/0298745 A1
(43) Pub. Date: Nov. 25, 2010

(54) HEAD CAP FOR HEAD PHYSICAL THERAPY

(75) Inventors: Shih-Ta Liu, Taoyuan County (TW); Shua-Lien Li, Taoyuan County (TW); Po-Chang Liu, Taoyuan County (TW); Yu-Jen Liu, Taoyuan County (TW)

Correspondence Address: VOLPE AND KOENIG, P.C., UNITED PLAZA, 30 SOUTH 17TH STREET, PHILADELPHIA, PA, 19103, US

(73) Assignee: BIBOTING INTERNATION CO., LTD., Taoyuan County (TW)

(21) Appl. No.: 12/751,168

(22) Filed: Mar. 31, 2010

(30) Foreign Application Priority Data
May 19, 2009 (TW) 098208754

(51) Int. Cl. A61H 7/00

(52) U.S. Cl. 601/12

(57) ABSTRACT

The head cap for the use of head physical therapy in the present invention is related that the head cap is covered the head when using the vacuum device to generate a negative pressure for treating the head by massaging the user's head and improving a blood circulation.

The head cap in the present invention includes a head housing with an opening and a hole, an auxiliary unit connected with the opening and having an air vent, a vacuum device connected with the air vent, and a cushion ring connected with the head housing, wherein the cushion ring and the head housing form a sealed space when a user inserts its head in the cushion ring and the vacuum device is configured to provide the negative pressure for the physical therapy.

### FIELD OF THE INVENTION

The invention is related to a head cap, more particularly to a head cap for a physical therapy.

### BACKGROUND OF THE INVENTION

Nowadays, manual or automated vacuum pump is commonly used in the cupping of the traditional Chinese Medicine and the therapy for augmenting women's breast and preventing against the breast disease. The vacuum pump is operated by providing a negative pressure to allow a cup to stick to human skin via suction. Therefore, the hyperemia and the promotion of the blood circulation are preformed to achieve the therapeutic effect on treated part of the body.

However, since the surface of the head is not smooth and there is a lot of hair thereon, the vacuum pump can not be well utilized to stick to the human skin via suction so that there is traditionally none of a head cap for a head physical therapy. In order to well stick to the skin during therapy, the head cap must be designed to increase the air tightness of the sealed space between the head cap and the user's head.

Therefore, to overcome the drawbacks from the prior art and to meet the present needs, the Applicant dedicated in considerable experimentation and research, and finally accomplished the “head cap for head physical therapy” of the present invention, which overcomes the above drawbacks. The present invention is briefly described as follows.

### SUMMARY OF THE INVENTION

To solve the above drawbacks, the present invention provides a head cap for increasing the air tightness of the sealed space between the head cap and the user's head so that the vacuum pump can be operated by providing a negative pressure to allow the head cap to stick to the head skin via suction.

According to the first aspect of the present invention, a device for a physical therapy is provided. The device includes: a head housing with an opening and a hole, an auxiliary unit connected with the opening and having an air vent, a vacuum device connected with the air vent, and a cushion ring connected with the head housing, wherein the cushion ring and the head housing form a sealed space when a user inserts its head in the cushion ring.

Preferably, the vacuum device is one of an auto-electrical vacuum pump and a manual vacuum pump and the head housing is integrally formed with the cushion ring.

Preferably, the auxiliary unit further includes a vibrator configured to provide a vibration massage to the user's head.

Preferably, the vacuum device is configured to discharge the air inside the sealed space.

Preferably, the auxiliary unit further includes an air valve configured to vent the air inside the sealed space.

Preferably, the auxiliary unit further includes a light source configured to emit a light.

Preferably, the auxiliary unit further includes a generator configured to provide one being selected from a group consisting of a negative ion, passive and negative ions and an ozone molecule.

Preferably, the auxiliary unit further includes a box configured to store one of a medicine and a care product.

Preferably, the head housing has a shape being one selected from a group consisting of a hemispherical cavity, a hemi-ellipsoidal cavity and an irregular-shaped cavity to cover the user's head.

Preferably, the cushion ring and the head housing are assembled by one being selected from a group consisting of an adhesion, a pressure, a thread engagement and a tenon joint.

Preferably, the cushion ring is a resilient ring to form the sealed space.

Preferably, the cushion ring is one being selected from a group consisting of a hollow ring, a solid ring, a cove ring and a folding ring.

Preferably, the physical therapy is caused by a negative pressure suction generated by the vacuum device for massaging the user's head and improving a blood circulation.

According to the second aspect of the present invention, a device for negative pressure suction is provided. The device includes: a head housing with a vent and a hole, and a cushion ring connected with the head housing, wherein the cushion ring and the head housing are configured to form a sealed container for massaging a user's head.

Preferably, the head housing further includes a containing room to configure therein at least one being selected from a group consisting of a vibrator, an air escape valve, a light source, a generator and a box.

Preferably, the head housing further includes at least one being selected from a group consisting of a vibrator, an air escape valve, a light source, a generator and a box.

Preferably, the device further includes an air sucking device coupled to the vent.

According to the third aspect of the present invention, a head cap for a physical therapy is provided. The device includes: a head housing unit having a head housing, a hole and a cushion ring connected with the head housing, wherein the cushion ring and the head housing form a sealed space when a user inserts its head in the cushion ring.

Preferably, the head housing further has a lower edge having the hole and adjacent to the cushion ring and the head housing unit further has an air vent and a vacuum device coupled to the air vent.

Preferably, the head housing further includes one being selected from a group consisting of a check valve, a pressure regulating valve and a pressure safety valve.

The present invention is capable to achieve the effects that the vacuum pump can be operated by providing a negative pressure to allow the head cap to stick to the head skin via suction and can accordingly overcome the drawbacks in the prior art. The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) is a diagram schematically illustrating the head cap with the manual vacuum pump according to a first preferred embodiment of the present invention;

FIG. 1(b) is a diagram schematically illustrating the head cap with the automated vacuum pump according to a first preferred embodiment of the present invention;

FIGS. 2(a)-2(c) are respectively the structure diagrams for illustrating the auxiliary unit, the head housing and the cushion ring according to a second preferred embodiment of the present invention;

FIG. 2(d) is the structure diagram for illustrating the head cap according to a second preferred embodiment of the present invention;

FIGS. 3(a)-3(c) are respectively cross-sectional views for illustrating the auxiliary unit, the head housing and the cushion ring according to a second preferred embodiment of the present invention;

FIG. 3(d) is a cross-sectional view for illustrating the head cap according to a second preferred embodiment of the present invention;

FIGS. 4(a)-4(c) are respectively cross-sectional views for illustrating the head housing with different combination components according to a third preferred embodiment of the present invention;

FIGS. 5(a)-5(c) are respectively cross-sectional views for illustrating the head housing with different air valves according to a forth preferred embodiment of the present invention;

FIGS. 6(a)-6(c) are respectively cross-sectional views for illustrating the head cap with light sources and different auxiliary units according to a fifth preferred embodiment of the present invention;

FIGS. 7(a)-7(d) are respectively cross-sectional views for illustrating the head cap with different cushion rings according to a sixth preferred embodiment of the present invention;

FIGS. 8(a)-8(b) are respectively cross-sectional views for illustrating the auxiliary unit with different additional function units according to a seventh preferred embodiment of the present invention;

FIGS. 8(c)-8(e) are respectively the structure diagrams for illustrating the auxiliary unit with different additional function units according to a seventh preferred embodiment of the present invention;

FIG. 8(f) is a cross-sectional view for illustrating the auxiliary unit with a light source and a pressure regulating valve according to a seventh preferred embodiment of the present invention; and

FIGS. 8(g)-8(j) are respectively cross-sectional views for illustrating the auxiliary unit with different air valves according to a seventh preferred embodiment of the present invention.

### DETAILED DESCRIPTION OF THE PREFERRED EMBODIMENT

The present invention will now be described more specifically by the following embodiments. However, it is to be noted that the following descriptions of preferred embodiments of this invention are presented herein for the purposes of illustration and description only; it is not intended to be exhaustive or to be limited to the precise form disclosed.

Moreover, in order to provide clearer descriptions more easily understood the present invention, the parts of the drawing do not draw in accordance with their relative sizes. Some sizes and scales have been exaggerated or magnified. The parts of unrelated details are not drawn completely to simplify the drawing.

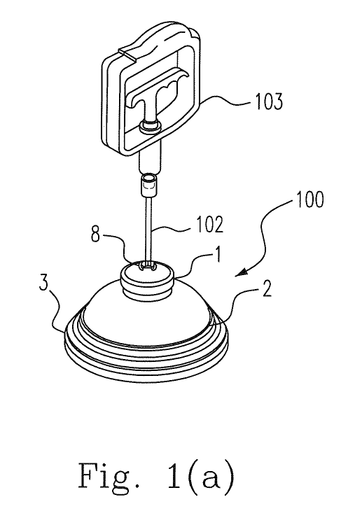

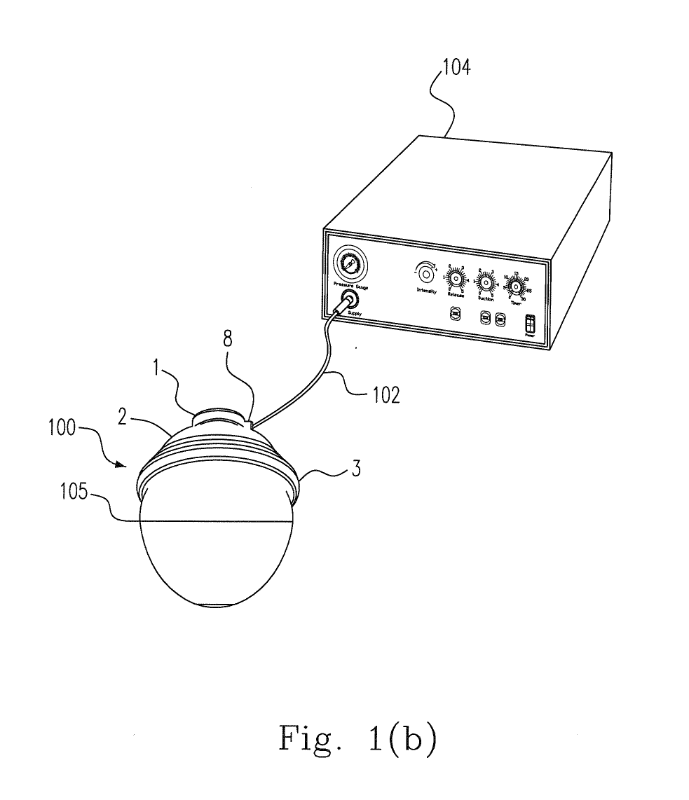

FIGS. 1(a)-1(b) are schematic diagrams respectively illustrating the head cap 100 with the manual vacuum pump 103 and automated vacuum pump 104 according to a first preferred embodiment of the present invention. The present invention provides a head cap 100 for the head physical therapy. The head cap 100 includes: an auxiliary unit 1 having an air vent 8, a head housing 2 and a cushion ring 3. In order to render the head cap 100 sticking to the head skin via suction, the head cap 100 must be connected with a vacuum device or a sucking device, such as the manual vacuum pump 103 and automated vacuum pump 104 by an air pipe 102 and the air vent 8. In addition, a user moves his/her head 105 into a hollow part at the center of the cushion ring 3 to try to form a sealed space for generating a negative pressure suction by the vacuum device so that the physical therapy is induced by the negative pressure suction for massaging the user's head 105 and improving a blood circulation. Since the air tightness of the sealed space is important to maintain the negative pressure suction, the cushion ring 3 is needed to be a resilient ring to fit the user's head 105 without air leakage.

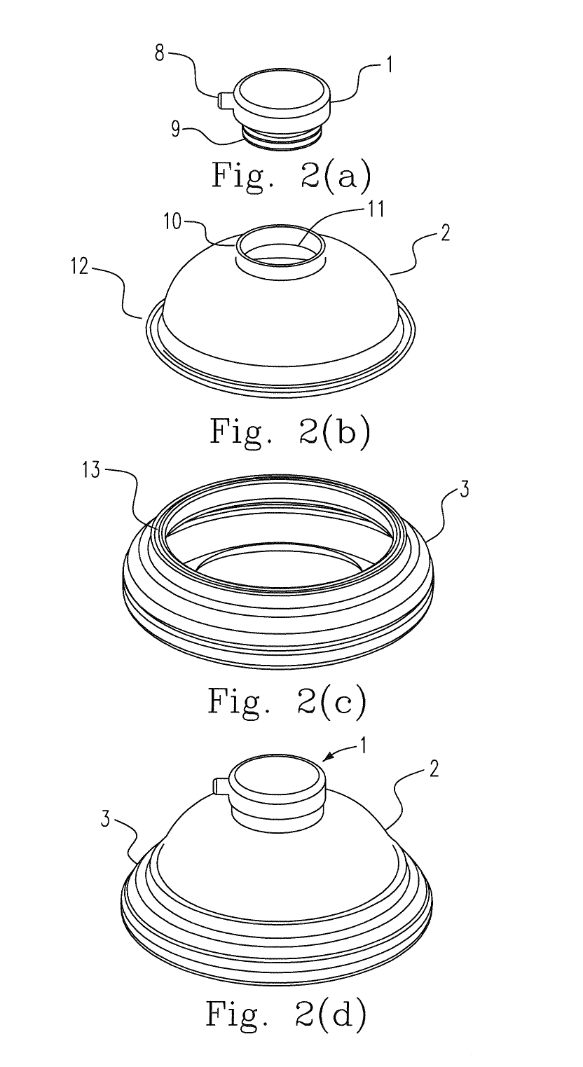

FIGS. 2(a)-2(c) are schematic diagrams respectively illustrating the auxiliary unit 1, the head housing 2 and the cushion ring 3 according to a second preferred embodiment of the present invention. The auxiliary unit 1 includes the air vent 8 and a first combination component 9 for connecting with the head housing 2. The head housing 2 includes a second combination component 11 for connecting with the auxiliary unit 1 at the opening 10 of the head housing 2 and a first combination part 12 for connecting with the cushion ring 3. The cushion ring 3 includes a second combination part 13 for connecting with the head housing 2. The auxiliary unit 1, the head housing 2 and the cushion 3 can be combined to form the head cap 100, which is showed in the FIG. 2(d).

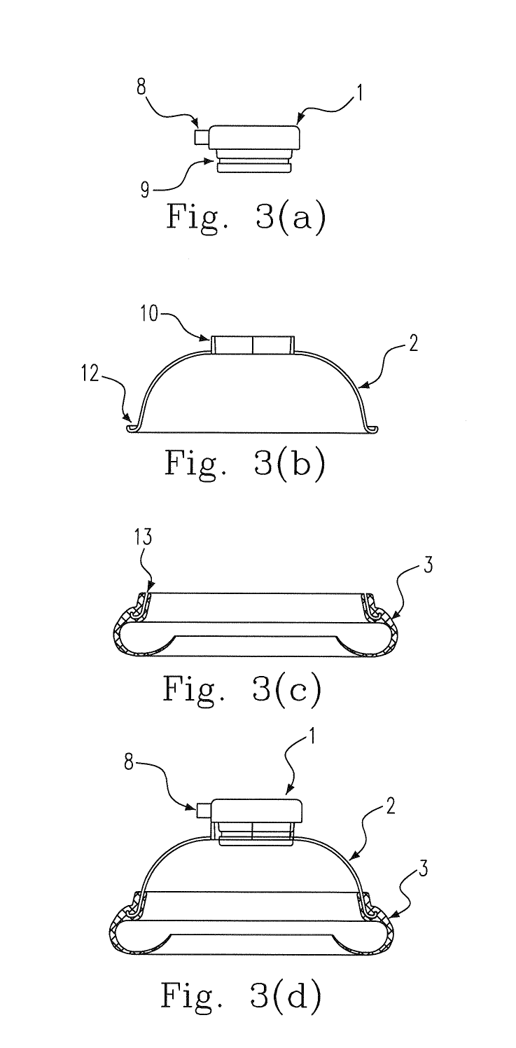

FIGS. 3(a)-3(b) are cross-sectional views for respectively illustrating the auxiliary unit 1, the head housing 2 and the cushion ring 3 according to a second preferred embodiment of the present invention. Since the cushion ring 3 is a resilient ring, the first combination part 12 of the head housing 2 can be compressed into the second combination part 13 for connecting with the cushion ring 3, which is showed in the FIG. 3(d).

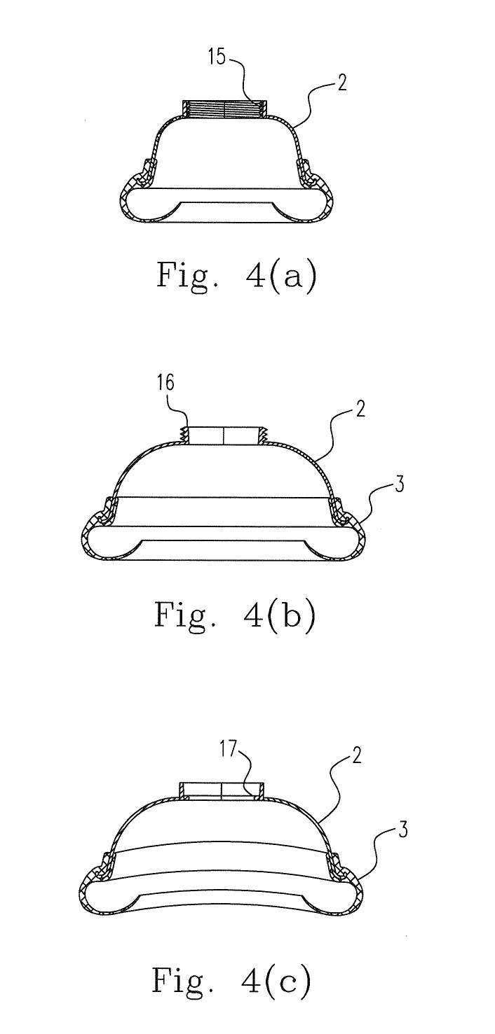

FIGS. 4(a)-4(c) are cross-sectional views for respectively illustrating the head housing 3 with different second combination components 11 according to a third preferred embodiment of the present invention. The second combination component 11 can be an internal thread 15 corresponding to an external thread to be a first combination component 9, an external thread 16 corresponding to an internal thread to be a first combination component 9 or an internal tenon 17 corresponding to an external tenon to be a first combination component 9.

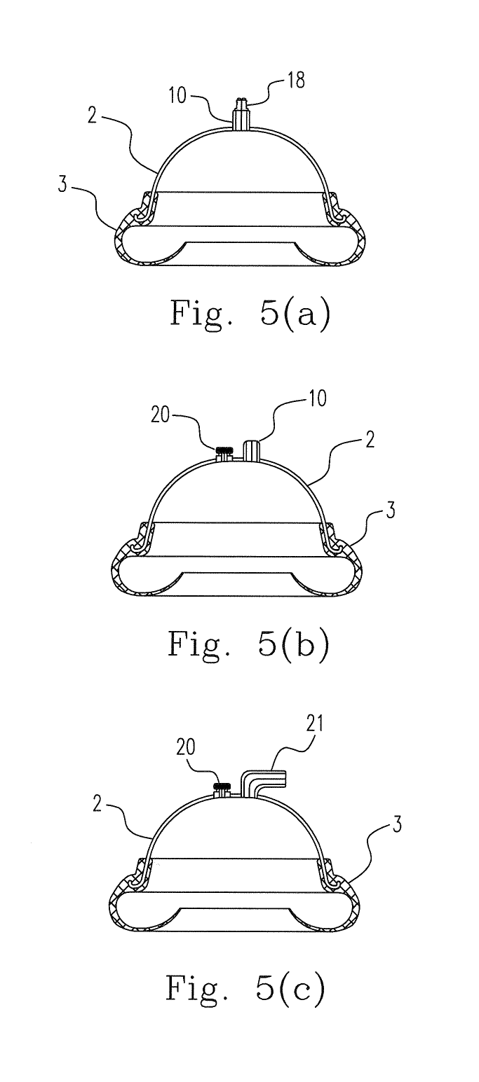

FIGS. 5(a)-5(c) are cross-sectional views for respectively illustrating the head housing 2 with different air valves according to a forth preferred embodiment of the present invention. The check valve 18 can be configured on the opening 10 to keep the negative pressure in the sealed space for preventing possible leakage, the pressure regulating valve 20 can be configured on the opening 10 to regulate the negative pressure in the sealed space, and the pressure safety valve can be configured on the opening 10 to avoid harming the user. In addition, the opening 10 can be large to make the auxiliary unit 1 to be configured thereon, which is showed in the FIG. 2, or small to be an air vent for connecting with all kinds of valves or the vacuum device. Moreover, the opening can be any kinds of shapes, such as a curved vent 21.

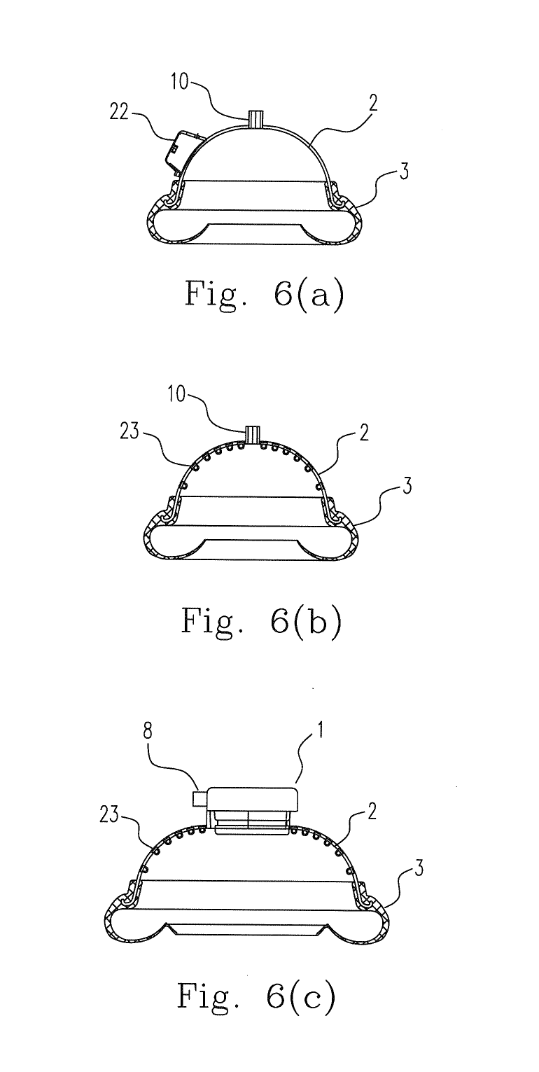

FIGS. 6(a)-6(c) are cross-sectional views for respectively illustrating the head cap 100 with light sources and different auxiliary units according to a fifth preferred embodiment of the present invention. The light source 23 can be configured on the internal surface of the head housing 2 to emit a light for a light therapy. Furthermore, the auxiliary unit 1 can be configured on the top of the head housing or configured integrally on the surface thereof to be the containing room 22.

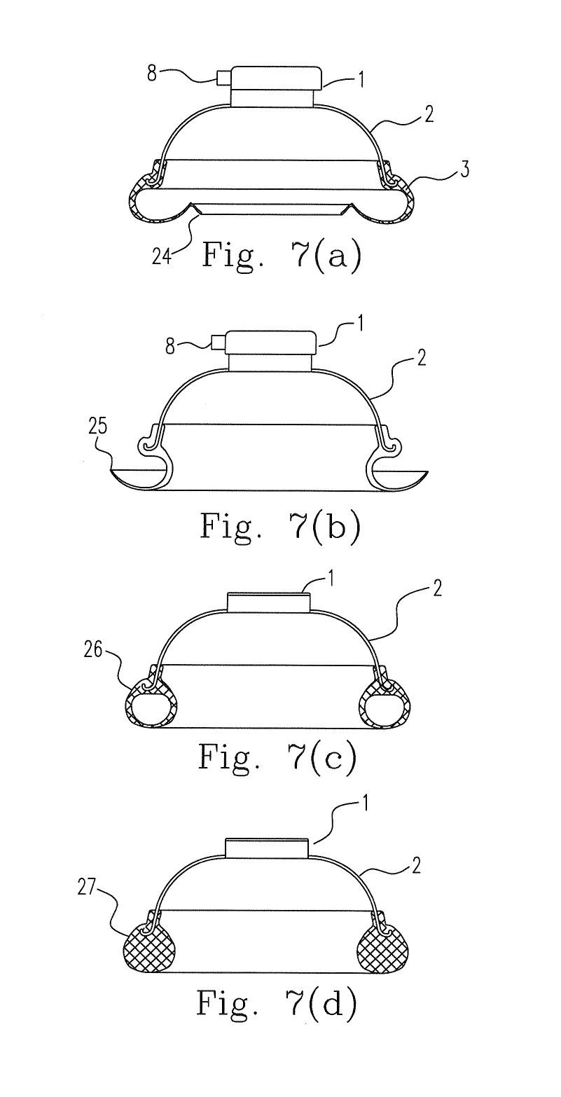

FIGS. 7(a)-7(d) are cross-sectional views for respectively illustrating the head cap 100 with different cushion rings 3 according to a sixth preferred embodiment of the present invention. The cushion ring 3 can be an internal curved ring 24, an external curved ring 25, a hollow ring 26 or a solid ring 27, wherein the internal curved ring includes a fold to be called as a folding ring. In addition, the internal curved ring 24 and external curved ring 25 respectively include a curve to be called as a cove ring.

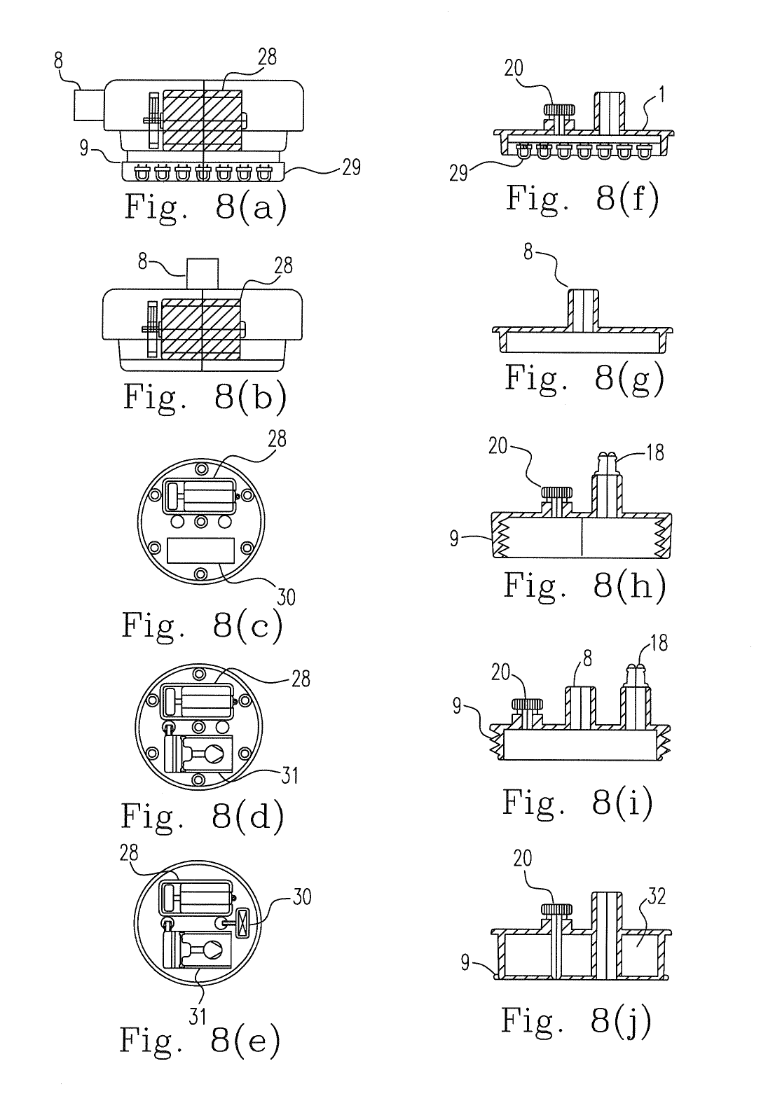

FIGS. 8(a)-8(j) are respectively illustrated the auxiliary unit 1 with different addition function units according to a seventh preferred embodiment of the present invention. The auxiliary unit 1 with different additional function units can provide different functions for the user. The vibrator 28 can be configured in the auxiliary unit 1 to provide a vibration message to the user's head. The light source 29 can be configured in the auxiliary unit 1 to emit a light for a light therapy. The generator 30 can be configured in the auxiliary unit 1 to provide a negative ion, passive and negative ions or an ozone molecule for the negative ion therapy. The vacuum device 31 is configured to discharge the air inside the sealed space, which is formed when the user moves his/her head into the cushion ring 3. The box 32 is configured in the auxiliary unit 1 to store a medicine or a care product to provide the medicine therapy or the care of the head or the hair.

The head housing 2 has many kinds of shapes so as to cover the user's head, like a hemispherical cavity, a hemi-ellipsoidal cavity and an irregular-shaped cavity. However, the user's head can be in different sizes and shapes. Therefore, the lower edge of the cushion ring 3 must be made to fit the use's head whether the hole formed by the lower edge of the head housing 2 is regular-shaped or not. In addition, the cushion ring 3 can be a resilient ring to fit the user's head.

In addition to configure the auxiliary unit 1 on the head housing, the auxiliary unit 1 can be integrated with the head housing 2 so that the auxiliary unit 1 can be called as a containing room 22, which is included in the head housing 2. Therefore, the additional function units like a vibrator 28, an air escape valve, a light source 29, a generator 30 or a box 32 can be configured in the containing room 22 to provide difference functions. Moreover, the additional function units can be directly configured on internal surface of the head housing 2 without the auxiliary unit 1 or the containing room 22. However, the auxiliary unit 1 has an advantage that the auxiliary units 1 with different additional function units can be configured on only one head housing 2 to provide many functions while the head housing 2 with additional function units and the head housing with the containing room can provide the functions which can not be changed when the head housing have been configured.

The cushion ring 3 and the head housing 2 can be assembled by a pressure to be fixed each other, which can be known by that the head housing 3 in FIG. 3(b) and cushion ring 2 in FIG. 3(c) can be formed the head cap 100 in FIG. 3(d) by a pressure. In addition, the cushion ring 3 and the head housing 2 can be adhered to each other or fixed by a thread engagement or a tenon joint. The combination method can not be limited by the above method so that all kinds of combination methods can be used in the present invention.

The head housing 2 and the cushion ring 3 can be integrated with each other to be a head housing unit. When a user moves his/her head in the cushion, the sealed space can be formed so that a vacuum device coupled the air vent on the head housing unit can provide a negative pressure for the physical therapy. Moreover, the head housing 2 has a lower edge having a hole and adjacent to the cushion ring 3 to make the user's head to be inserted.

However, the user's head can be in different sizes and shapes so that the head housing unit may not be used because the user's head is too large, small, or irregular-shaped. Therefore, the head housing unit is needed to manufacture a series of the head housing unit to fit the user's head.

If the head housing, the auxiliary unit and the cushion ring are manufactured respectively, different auxiliary units can be assembled on the head housing to provide different functions and different cushion rings can be assembled on the head housing to fit the user's head in different sizes and shapes.

While the invention has been described in terms of what are presently considered to be the most practical and preferred embodiments, it is to be understood that the invention should not be limited to the disclosed embodiment. On the contrary, it is intended to cover numerous modifications and variations included within the spirit and scope of the appended claims which are to be accorded with the broadest interpretation so as to encompass all such modifications and variations. Therefore, the above description and illustration should not be taken as limiting the scope of the present invention which is defined by the appended claims.

What is claimed is:

1. A device for a physical therapy, comprising:
a head housing with an opening and a hole;
an auxiliary unit connected with the opening and having an air vent;
a vacuum device connected with the air vent; and
a cushion ring connected with the head housing, wherein the cushioning and the head housing form a sealed space when a user inserts its head in the cushion ring.

2. The device as claimed in claim 1, wherein the vacuum device is one of an auto-electrical vacuum pump and a manual vacuum pump and the head housing is integrally formed with the cushion ring.

3. The device as claimed in claim 1, wherein the auxiliary unit further comprises a vibrator configured to provide a vibration massage to the user's head.

4. The device as claimed in claim 1, wherein the vacuum device is configured to discharge the air inside the sealed space.

5. The device as claimed in claim 1, wherein the auxiliary unit further comprises an air valve configured to vent the air inside the sealed space.

6. The device as claimed in claim 1, wherein the auxiliary unit further comprises a light source configured to emit a light.

7. The device as claimed in claim 1, wherein the auxiliary unit further comprises a generator configured to provide one being selected from a group consisting of a negative ion, passive and negative ions and an ozone molecule.

8. The device as claimed in claim 1, wherein the auxiliary unit further comprises a box configured to store one of a medicine and a care product.

9. The device as claimed in claim 1, wherein the head housing has a shape being one selected from a group consisting of a hemispherical cavity, a hemi-ellipsoidal cavity and an irregular-shaped cavity to cover the user's head.

10. The device as claimed in claim 1, wherein the cushion ring and the head housing are configured by one being selected from a group consisting of an adhesion, a pressure, a thread engagement and a tenon joint.

11. The device as claimed in claim 1, wherein the cushion ring is a resilient ring to form the sealed space.

12. The device as claimed in claim 1, wherein the cushion ring is one being selected from a group consisting of a hollow ring, a solid ring, a cove ring and a folding ring.

13. The device as claimed in claim 1, wherein the physical therapy is caused by a negative pressure suction generated by the vacuum device for massaging the user's head and improving a blood circulation.

14. A device for negative pressure suction, comprising:
a head housing with a vent and a hole; and
a cushion ring connected with the head housing, wherein the cushion ring and the head housing are configured to form a sealed container for massaging a user's head.

15. The device as claimed in claim 14, wherein the head housing further comprises a containing room to configure therein at least one being selected from a group consisting of a vibrator, an air escape valve, a light source, a generator and a box.

16. The device as claimed in claim 14, wherein the head housing further comprises at least one being selected from a group consisting of a vibrator, an air escape valve, a light source, a generator and a box.

17. The device as claimed in claim 14 further comprising an air sucking device coupled to the vent.

18. A head cap for a physical therapy, comprising:
a head housing unit having a head housing, a hole and a cushion ring connected with the head housing, wherein the cushion ring and the head housing form a sealed space when a user inserts its head in the cushion ring.

19. The head cap as claimed in claim 18, wherein the head housing further has a lower edge having the hole and adjacent to the cushion ring and the head housing unit further has an air vent and a vacuum device coupled to the air vent.

20. The head cap as claimed in claim 18, wherein the head housing further comprises one being selected from a group consisting of a check valve, a pressure regulating valve and a pressure safety valve.
